(19) United States
(12) Patent Application Publication
(10) Pub. No.: US 2026/0273646 A1
(43) Pub. Date: Sep. 17, 2026

(54) Zero Emission Railroad Tracks Welder

(71) Applicants: Ameer Alghusain, Suisun City, CA (US); Cesar Diaz, San Jose, CA (US)

(72) Inventors: Ameer Alghusain, Suisun City, CA (US); Cesar Diaz, San Jose, CA (US)

(21) Appl. No.: 19/669,368

(22) Filed: May 6, 2026

Related U.S. Application Data
(60) Provisional application No. 63/805,289, filed on May 13, 2025.
(60) Provisional application No. 63/815,873, filed on Jun. 1, 2025.

(51) Int. Cl. B23K 11/04; B23K 11/24; B23K 11/28; B23K 101/26; E01B 11/50; E01B 29/42

(52) U.S. Cl. CPC B23K 11/043; B23K 11/246; B23K 11/28; E01B 11/50; E01B 29/42; B23K 2101/26

(57) ABSTRACT

A zero-emission power system for mobile rail flash-butt welding operations, providing an environmentally friendly alternative to conventional diesel generators. The system integrates either (i) modular rechargeable battery packs with a high-efficiency, programmable three-phase inverter or (ii) a hydrogen fuel cell generator, both engineered to meet the demanding requirements of QUIKWELD™ AC and DC welding systems, supporting peak loads of up to 500 kVA and continuous current draws of 400 A. In the battery configuration, DC power from 800-1000 kWh modular battery packs is converted into stable 400V, three-phase, 50 Hz AC power, with auxiliary inverters supporting hydraulic and cooling subsystems, and optional direct DC output for DC welding heads. In the hydrogen configuration, the fuel cell directly supplies stable AC power through continuous electrochemical generation, eliminating the need for energy storage and reducing operational downtime. Both configurations enable a fully electrified, mobile, zero-emission welding platform with high power output, operational flexibility, and reduced noise and maintenance burdens. The system is further extendable to power a wide range of railroad maintenance and construction equipment, enhancing sustainability across rail infrastructure operations.

### TECHNICAL FIELD

The present invention generally relates to electric flash-butt welding of railroad tracks utilizing high electric current, operable in either alternating current (AC) or direct current (DC) flashing modes.

### BACKGROUND

Thermite ThermoChemical™ welding is the process of igniting a mix of high energy iron oxide and aluminum powder materials, which produces a molten metal that is poured between the working pieces of metal to form a welded joint. Aluminum reduces the oxide of another metal, most commonly iron oxide, because aluminum is highly reactive, the Thermite ThermoChemical™ reaction is described in the following formula:

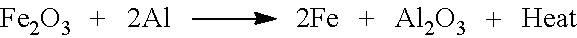

Commonly, the reacting composition is iron oxide powder and aluminum powder, ignited at high temperatures. A strongly Thermite ThermoChemical™ (heat-generating with temperature of more than 1,400° C. (1,670 K)) reaction occurs that produces through reduction and oxidation a hot mass of molten iron and a slag of refractory aluminum oxide. The molten iron is the actual welding material (after cooling down, it becomes the final welding material); the aluminum oxide is much less dense than the liquid iron and so floats to the top of the reaction, so the setup up for welding must take into account that the actual welding material is on the bottom and covered by floating slag.

Thermite ThermoChemical™ welding is widely used to weld railroad rails tracks. Typically, the ends of the rails are cleaned, aligned flat and true, and spaced accordingly where a mold made of graphite or sand is clamped around the rail ends, and a compressed-gas torch is used to preheat the ends of the rail. The proper amount of Thermite ThermoChemical™ with alloying metal is placed in a refractory funnel, and when the rails have reached a sufficient temperature, the Thermite ThermoChemical™ is ignited and allowed to react to completion (allowing time for any alloying metal to fully melt and mix, yielding the desired molten steel or alloy). The reaction crucible is then tapped at the bottom (leaving the aluminum oxide in the crucible), the molten steel flows into the mold, fusing with the rail ends and forming the weld. The entire setup is allowed to cool. The mold is removed and the weld is cleaned by chiseling and grinding to produce a smooth joint. Typical time from start of the work until a train can run over the rail is approximately one half hour. Ignition of a Thermite ThermoChemical™ reaction normally requires magnesium ribbon or electrical igniters or flint gun. Few examples of electrical igniters and flint guns are commercialized by AMERICAN RAILWAYS™ LLC under the QUIKWELD™ Process. Manufacturers of Thermite ThermoChemical™ welding kits are few worldwide and there are three original manufacturers, (1) PANDROL® RAILTECH with HQ office in France, (2) Orgo-Thermit®, a member of Goldschmidt-Thermit^{®}Group with HQ office in Germany and (3) AMERICAN RAILWAYS™, A US RAILWAYS™ Company with HQ office in USA.

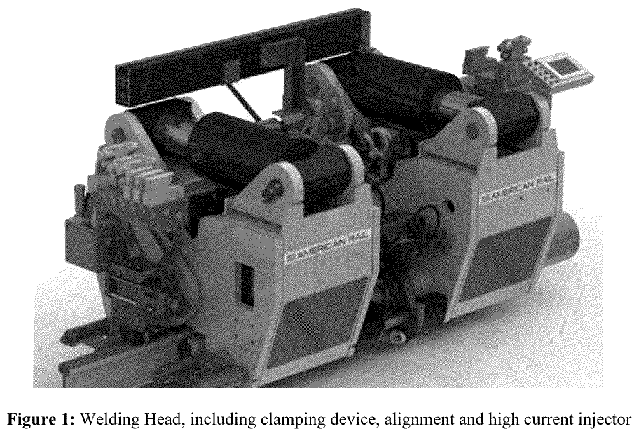

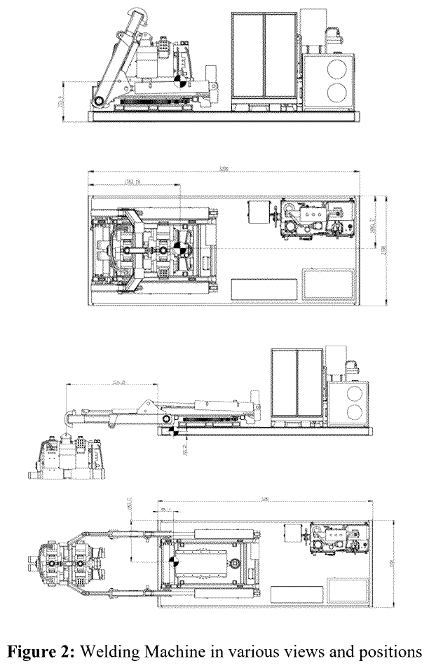

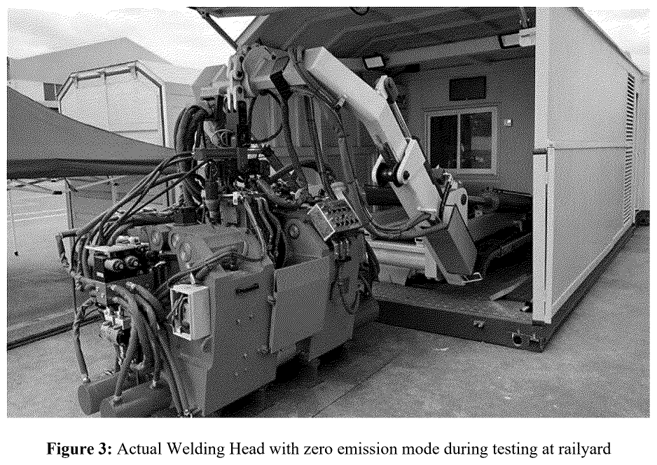

A more expensive rail tracks welding technology is identified as an Electric Flash-butt welding system, consisting of power sources fed by diesel generator, compromising of a resistance welding process where two metal pieces are joined by applying a high current, causing localized melting and then forcing the ends together under pressure. This process removes irregularities and impurities, resulting in a strong, high-quality weld. Flash-butt welding has become a premier welding method for rail operations, due to the clean, consistent welds it produces. AMERICAN RAILWAYS™, A US RAILWAYS™ designs and manufactures flash butt welding systems and machines worldwide and most of them are still working today on international railroad lines. AMERICAN RAILWAYS™, A US RAILWAYS™ is an original manufacturer of electric flash-butt welding machines in various designs: AC and DC operating systems, mobile, or in track, off-track, mounted on a truck, on a railroad car or as stationary factory setup. AMERICAN RAILWAYS™, A US RAILWAYS™, welding technologies, products and services are marketed globally under the trademark and brand name QUIKWELD™ welders, and they are universal and state-of-the-art top quality and innovative machines that are equipped with easy tools and spare parts suitable for the electric flash-butt welding of any rail size. AMERICAN RAILWAYS™, A US RAILWAYS™, flash-butt rail welders are a ready-for-service from day one of delivery, either in-track or off-track. The welders today are powered by a diesel engine generator set and managed by smart control software and internal cooling system to provide a stable welding process and top quality of welds at the highest efficiency and productivity possible in industry. The welding head, with the ability to achieve 150T pulling force of railroad tracks, is designed to provide highest standard on quality and tolerances of rail welding in-track, off track and in stationary factory setup. The system completes a welding cycle from aligning, pulling, flashing and removing excessive metals in one automatic sequence controlled by operators using, on site or off site, wired or wireless control. The welders can perform high quality welding of various rail profiles, including international UIC60, TR68, TR57 & TR50, per UIC and American Standards rail profiles 115 RE and 136 RE per American Railway Engineering and Maintenance-of-Way Association (AREMA®) Chapter 4, Rail standards. A picture of a welding device is attached below. FIG. 1 shows the Welding Head, including clamping device, alignment and high current injector. FIG. 2 shows the Welding Machine in various views and positions.

The invention comprises a rechargeable battery and inverter system designed to replace traditional diesel generators. The inverter is a programmable, high-efficiency, three phase AC converter capable of supporting the welding load profile of the QUIKWELD™ 120AC machine, including up to 500 kVA peak demand and 400 A draw. The battery-inverter unit supplies stable 400V, 3-phase, 50 Hz power using solid-state switching and integrated thermal regulation. Modular battery packs with 800-1000 kWh capacity ensure full operational range, while auxiliary inverters support the hydraulic pump and cooling systems. The result is a fully electrified, zero-emission rail welding platform.

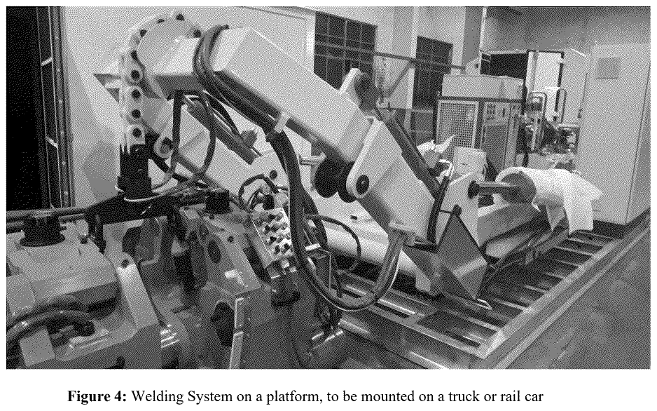

The welding system consists of welding head lifted by a crane, a generator power supply system, cooling systems, hydraulic oil system, pumping station, electrical wires, complex software and controls placed on a platform that can be mounted on truck or rail car, below is a picture of the platform. FIG. 3 shows an Actual Welding Head with zero emission mode during testing at railyard.

The invention also comprises the option of hydrogen fuel cell power system designed to replace traditional diesel generators. The hydrogen fuel cell system continuously produces electricity through an electrochemical reaction of hydrogen and oxygen, delivering stable three-phase 400V, 50 Hz AC power suitable for powering the welding equipment. This configuration supports the welding load profile of the QUIKWELD™ 120AC machine, including up to 500 kVA peak demand and 400 A draw. The system is fully electrified and zero-emission, with no combustion byproducts—only water vapor as a result of hydrogen consumption. Auxiliary subsystems are powered directly by the fuel cell system, including the hydraulic pump and cooling units, enabling seamless operation in the field. The welding system consists of a welding head lifted by a crane, a fuel cell power generation system, cooling systems, hydraulic oil system, pumping station, electrical wiring, and complex software and control components placed on a platform that can be mounted on a truck or rail car, below is a picture of the platform.

The welding system, either powered by batteries or hydrogen fuel cell power system can be mounted on a truck, rail car or electrical vehicles, a picture of an example is shown below. FIG. 4 shows the Welding System on a platform, to be mounted on a truck or rail car

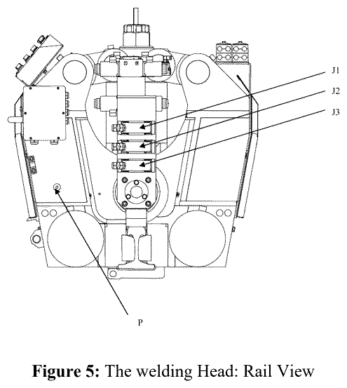

The welding head includes two clamping mechanisms, flashing and upset mechanism, hydraulic system, pulling device, independent trimming device, two welding transformers mounted in each jaw of left clamping mechanism, control electric, and water-cooling system. A picture of the welding head is shown below in FIG. 5 (The welding Head: Rail View).

The control cabinet comprises an automatic, programmable, microprocessor-based system specifically designed to control the actuators and mechanisms of the QUIKWELD™ 120AC mobile welding machine used for butt induction rail welding. The control system enables:
Operation and management of the welding machine's actuators and mechanisms in both manual and semi-automatic modes;
Execution of the welding process cycle in accordance with a predefined welding cycle program, adaptable based on the travel of the moving frame and capable of supporting either continuous or pulsating flashing modes;
Real-time tolerance verification and parameter monitoring of the welding cycle, with automated generation of a certificate for each welded joint, indicating its usability or identifying any defects.

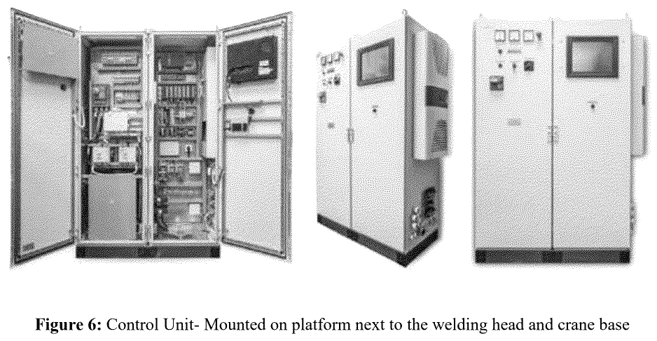

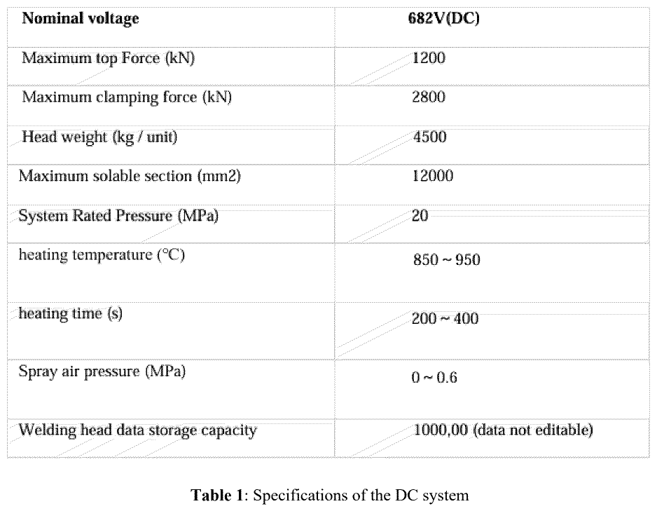

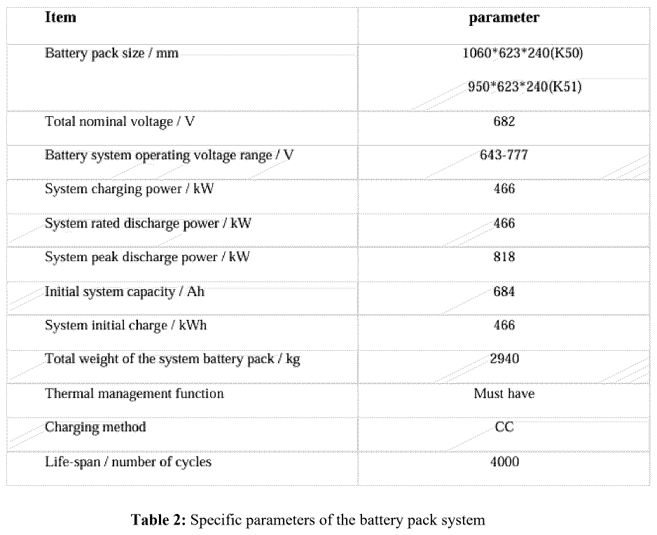

The control system of welding machine includes a control cabinet and control panel shown in FIG. 6: Control Unit-Mounted on platform next to the welding head and crane base.

The cooling system is constructed as a Monoblock unit, featuring a metal frame enclosed by protective, decorative, and quick-detachable panels. The system is equipped with five 1″ union fittings—four designated for the inlet connection of hydraulic oil and water supply lines to the heat exchangers, and one for fluid replenishment. Additionally, a ball valve is provided for draining fluid from the reservoir.

The system includes an integrated control panel with a programmable electronic processor, which facilitates the setting and automatic regulation of the desired fluid temperature within the vessel. The control unit also monitors and indicates operational status as well as emergency conditions.

Key components of the cooling system include:
A pressure-tight spiral compressor fitted with shutoff valves on both suction and discharge lines;
An air-cooling conditioner;
A laminar heat exchanger (evaporator) featuring a stainless steel heat exchange surface;
A receiver unit with shutoff valves and a thermal fuse;
A thermostatic expansion valve, drying filter, pressure switch, solenoid valve, and sight glass;
A plastic, thermally insulated fluid reservoir;
A water circulation pump;

Two laminar heat exchangers for water and hydraulic oil cooling;
Two solenoid valves controlling the flow of cooling water to the heat exchangers;
A microprocessor-based automatic control system designed for precise temperature regulation and plant protection against operational faults or emergencies.

The welding head is mounted and maneuvered using a crane system capable of lifting and transporting a load of up to 5 tons. The crane facilitates multi-directional positioning and orientation of the welding head relative to the rail axis.

The horizontal swing range of the lifting arm is ±60°, enabling precise alignment with the rail ends. The hydraulic lift includes a sliding section with an adjustable stroke ranging from 0 to 1000 mm, allowing vertical repositioning of the welding head. The lift mechanism incorporates a rotary platform, which, in its retracted or “combined” configuration, supports the welding head directly on the platform itself. The crane system enables the welding head to be lifted off the platform and lowered into the operational position, such that the bottom edge of the welding assembly extends approximately 150-200 mm below the top surface of the rails to be welded.

In the past, AMERICAN RAILWAYS™ LLC used various diesel generators designs to provide 50 Hz, 400 VAC, 650 A, 3 Phase 4 wires at 1500 rpm, equipped with a radiator and the cooling fan, enhanced by electronic regulator of the engine, fueled by diesel fuel contained in a fuel tank attached to the welding system.

### SUMMARY

This invention presents a pre-engineered, intelligently integrated, zero-emission power system designed to replace conventional diesel generators in electric flash-butt rail welding operations. The system is capable of delivering stable three-phase 400V AC power at 50 Hz to support continuous operation of welding equipment—including the welding head, control cabinet, hydraulic systems, and cooling units—while meeting peak load demands of up to 500 kVA.

The system operates through two primary energy configurations:
1. Battery-Based System:

Utilizes high-capacity, modular rechargeable battery packs ranging from approximately 800 to 1000 kWh. These are paired with a high-efficiency, programmable solid-state inverter that converts DC battery output into stable AC power. The inverter incorporates integrated thermal regulation and is designed for consistent, high-output performance, supporting demanding applications such as the QUIKWELD™ 120AC flash-butt welding machine with current requirements up to 400 A.
2. Hydrogen Fuel Cell System (Optional):

Employs a direct hydrogen fuel cell energy source that generates stable three-phase 400V AC power via an electrochemical process. This configuration enables continuous, high-output operation over extended periods without the need for recharging or supplemental energy storage, supported by integrated thermal management systems.

A key feature of the invention is the modular inverter architecture, which ensures scalable, reliable power delivery across varying operational demands while maintaining zero-emission performance.

Additionally, the system includes a rugged, high-temperature-tolerant interface module positioned between the welding head and the power control system. This interface may be reusable or expendable, is compatible with multiple rail sizes and profiles, and can be configured on one or both sides of the welding platform. It enhances durability, operational flexibility, and performance in demanding field conditions.

Overall, the invention provides a fully electric (or hydrogen-assisted), zero-emission flash-butt welding solution optimized for high-power industrial rail applications, eliminating reliance on diesel generation while maintaining or exceeding conventional performance standards.

The QUIKWELD™ system is a fully integrated, zero-emission rail welding platform designed for high-performance flash-butt welding operations in modern rail infrastructure projects. The system comprises a power compartment, operator cabin, advanced energy supply system, water cooling unit, compressed air and hydraulic subsystems, welding main circuit, electrical control system, dual-arm crane, welding and heat-treatment head, and embedded control software.

The energy supply system is configurable in two primary modes:
1. Battery-Based Configuration:

Utilizes a high-capacity onboard battery system to provide stable, continuous electrical power for all welding and auxiliary operations.
2. Hydrogen Fuel Cell Configuration:

Incorporates a hydrogen fuel cell generator capable of delivering consistent, zero-emission power for extended operation without reliance on recharging infrastructure.

Both configurations eliminate the need for conventional diesel generators while ensuring reliable delivery of power to the welding process and all supporting subsystems.

The system integrates advanced electrical controls and embedded software to coordinate welding operations, power distribution, thermal management, and subsystem performance. Supporting systems—including water cooling, compressed air, and hydraulics—are fully electrified and optimized for sustained high-load industrial use.

A dual-arm crane system enhances material handling and positioning efficiency, while the welding and heat-treatment head enables precise, high-quality rail joining and post-weld processing. Overall, the QUIKWELD™ system delivers a modular, scalable, and environmentally compliant solution that improves operational efficiency, reduces emissions, and increases deployment flexibility across a wide range of rail construction and maintenance environments.

The system is equipped with a rail flash welding function, which ensures consistent rail pressure throughout the entire welding process, facilitating efficient and stable joint formation. The specifications of the DC system are outlined in Table 1: Specifications of the DC system.

The battery pack system serves as the primary power source for the entire welding machine. By utilizing a DC welding power supply, the system employs a three-phase rectification inverter to convert power into medium-frequency AC square wave output. The secondary welding circuit operates in DC mode, achieving a power factor exceeding 90%. This design significantly enhances the power utilization rate. In accordance with the flash welding parameter requirements, the following are the specific parameters of the battery pack system shown in Table 2: Specific parameters of the battery pack system

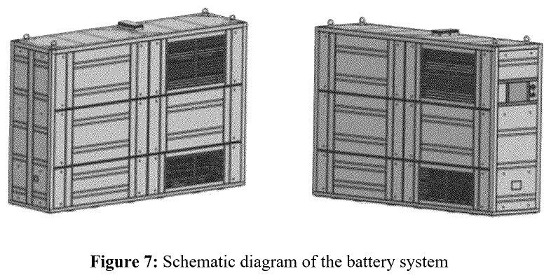

The battery pack is integrated with several critical systems, including a Battery Management System (BMS), a fire protection system, a cooling system, and a thermal management system. These components work together to ensure optimal performance, safety, and longevity of the battery pack. A schematic diagram of the battery system is provided below for reference in FIG. 7: Schematic diagram of the battery system The battery pack panels are equipped with various essential components, including cable terminals, an emergency stop button, a 24V power supply control knob, charge and discharge knobs, a status indicator, a communication port, and a BMS touch screen. These features are designed to provide easy access to critical functions and ensure efficient monitoring and control of the system. The Battery Management System (BMS) oversees the management of the entire battery stack, including monitoring battery status, performing analysis, collecting data, and coordinating the operation of each cluster. Through integration with the upper computer management system, the BMS provides real-time information on the battery stack, such as individual battery status, overall battery power, fault alerts, and alarm notifications. The BMS is also responsible for regulating charging and discharging processes. For example, during charging, it applies a high-current mode when the battery's power is low and switches to a low-current mode as the power increases. This results in faster charging when the battery is low and slower charging as it reaches full capacity. As the core control unit of the entire battery system, the BMS plays a pivotal role in system performance and safety. Additionally, its user interface can be customized to suit various configurations. The present invention describes a high-capacity inverter and energy storage system designed to provide 400-500 kVA peak 3-phase AC power sourced from rechargeable lithium-based battery modules. The system's inverter is responsible for converting the DC output from the battery (typically 600-800 VDC) into 400 VAC, 3-phase AC power at a frequency of 50 Hz. This is achieved using IGBT-based inverter stacks with programmable voltage and frequency control.

The system comprises the following components:
Modular Lithium-Ion Battery Packs: Providing a total energy storage capacity of 800 1000 kWh, sufficient to support a full welding shift operation.
Battery Management System (BMS): Equipped with thermal regulation, real-time monitoring, and overload protection features to ensure safe and efficient operation.
Redundant IGBT Inverter Arrays: Rated for up to 500 kVA peak load, ensuring reliability and high performance under varying operational conditions.
Cooling System Integration: Includes active cooling solutions for both the inverter and battery modules to maintain optimal operating temperatures.
Auxiliary Inverters: Dedicated units powering the control cabinet, pump station, and cooling system, with a continuous load capacity between 18.5-25 kW.

The system is designed for mobile deployment, allowing it to be mounted on a truck or rail car, thus replacing traditional diesel generator containers. This configuration significantly reduces noise, emissions, and fuel dependency while enabling quiet, night-time, and tunnel welding operations.

Power Requirement Summary for the AC QUIKWELD™ System:
Input Voltage: 380-440V AC, 3-phase, 50 Hz
Rated Power Consumption: 250 kVA
Peak Short-Circuit Power Requirement: Up to 500±55 kVA
Rated Current Draw: 400 A
Welding Output: 21-23 kA secondary circuit current
Hydraulic Pump Power: 18.5 kW
Cooling System Load: 40+ L/min flow (electric pump)

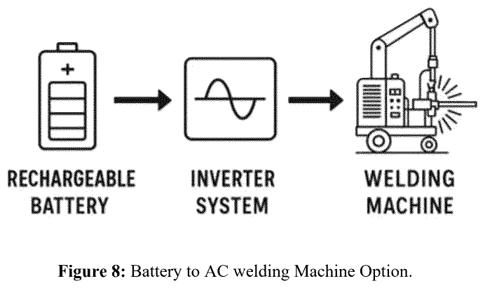

A flow chart of Battery to AC welding machine is shown in FIG. 8: Battery to AC welding Machine Option.

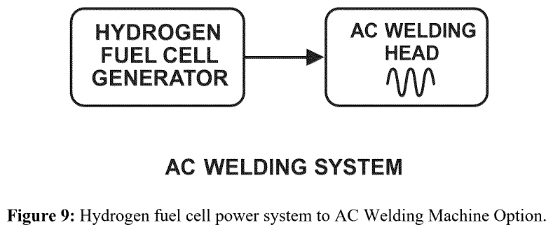

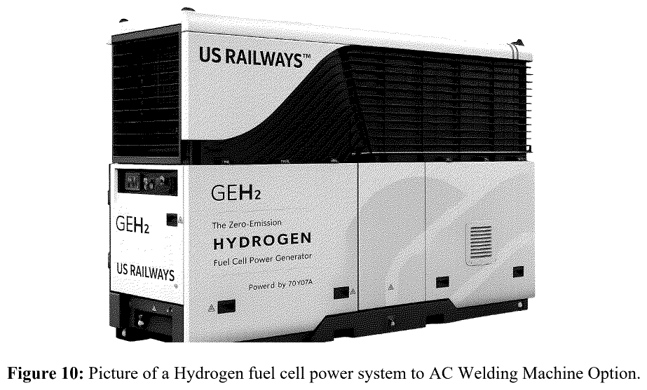

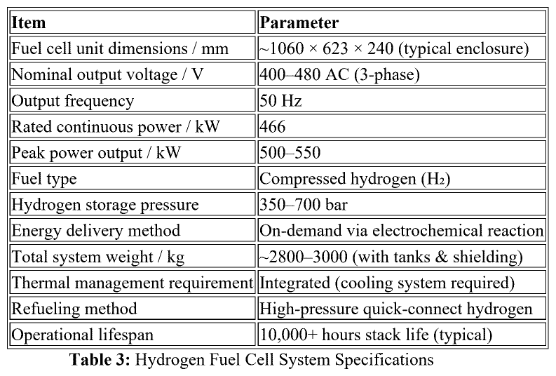

In the hydrogen fuel cell power system option, the power follow is shown in FIG. 9: Hydrogen fuel cell power system to AC Welding Machine Option. In the hydrogen fuel cell power system option, a picture of an actual hydrogen generator and related system is mounted on the truck chassis, as a whole, a picture is shown in FIG. 10: Picture of a Hydrogen fuel cell power system to AC Welding Machine Option.

As an alternative option to batteries, the hydrogen fuel cell system serves as the primary power source for the entire welding machine. It delivers stable three-phase AC power directly to the welding equipment, eliminating the need for battery storage or power conversion via inverters. The fuel cell provides continuous energy output to support all operational demands, including welding, hydraulic actuation, and cooling processes. This architecture enhances power utilization and system efficiency while maintaining a zero-emission profile.

In accordance with the flash welding parameter requirements, the following are the required performance characteristics of the fuel cell-powered system in Table 3: Hydrogen Fuel Cell System Specifications

The system, either battery-powered or hydrogen-powered, is designed for mobile deployment, allowing it to be mounted on a truck or rail car, thus replacing traditional diesel generator containers. This configuration significantly reduces noise, emissions, and fuel dependency while enabling quiet, night-time, and tunnel welding operations.

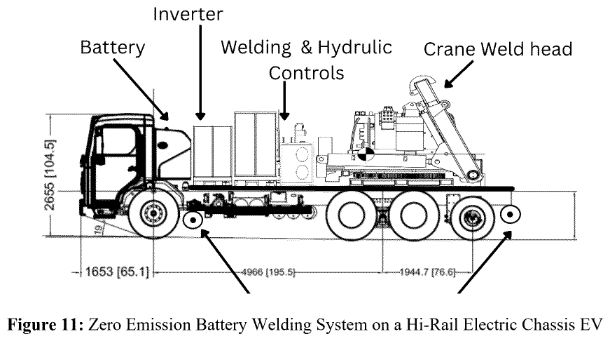

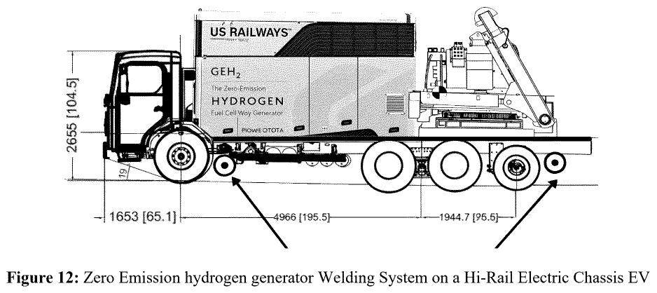

A Final concept of future battery-powered Hi-Rail rail flash butt welding EV is shown in FIG. 11: Zero Emission Battery Welding System on a Hi-Rail Electric Chassis EV, and A Final concept of hydrogen-powered Hi-Rail rail flash butt welding EV is shown below in FIG. 12: Zero Emission hydrogen generator Welding System on a Hi-Rail Electric Chassis EV.

What is claimed is:

1. A zero-emission mobile flash-butt railroad welding system comprising: (a) a rechargeable battery power source configured to supply electrical energy; (b) a power conversion system configured to selectively provide direct current (DC) and/or alternating current (AC) electrical output; (c) a flash-butt welding head configured to perform rail welding operations; and (d) a mobile platform comprising a railcar, hi-rail vehicle, electric vehicle, or truck; wherein the rechargeable battery power source supplies electrical power to the welding head and associated subsystems without reliance on a diesel generator.

2. The system of claim 1, wherein the power conversion system comprises one or more inverters configured to convert DC from the battery power source into three-phase AC suitable for flash-butt welding.

3. The system of claim 1, wherein the system is configured to supply DC power directly to a DC welding head without inversion.

4. The system of claim 1, further comprising a power regulation system configured to condition voltage and current for the welding head and auxiliary systems.

5. The system of claim 1, wherein the system is rated to provide up to approximately 500 kVA of electrical output.

6. The system of claim 1, further comprising an electrical control system configured to dynamically regulate power delivery based on welding demand.

7. The system of claim 1, wherein the rechargeable battery power source comprises one or more modular battery packs.

8. The system of claim 7, wherein the modular battery packs are removable and replaceable in the field to reduce system downtime.

9. The system of claim 7, wherein the modular battery packs comprise blade-format battery modules configured to be stacked, swapped, and rapidly recharged.

10. The system of claim 9, wherein the battery packs are configured to recharge to operational capacity within approximately 3 to 10 minutes using a high-power charging source.

11. The system of claim 7, wherein the battery packs comprise one or more chemistries selected from lithium iron phosphate (LFP), lithium manganese iron phosphate (LMFP), sodium-ion, semi-solid-state, or solid-state batteries.

12. The system of claim 1, further comprising a battery management system and thermal control system configured to maintain the battery within a predefined operating range.

13. The system of claim 1, further comprising a charging interface configured to supply electrical energy to the battery power source.

14. The system of claim 13, wherein the charging interface comprises one or more of: (a) conductive DC fast charging; (b) bidirectional DC-to-DC charging; (c) wireless inductive charging; (d) embedded inductive infrastructure charging; or (e) overhead conductive charging.

15. The system of claim 1, further comprising a hydrogen fuel cell system configured to supply electrical power as an alternative or supplemental energy source to the rechargeable battery power source.

16. The system of claim 15, wherein the hydrogen fuel cell system is configured to provide electrical power directly to the welding head or through the power conversion system.

17. The system of claim 15, further comprising a hydrogen storage, refueling, and safety management system integrated with the mobile platform.

18. The system of claim 1, wherein the system is integrated into an electric vehicle drivetrain or onboard energy system of the mobile platform.

19. The system of claim 1, further comprising a hi-rail wheel system configured for selective deployment to enable operation on both roadway and railway infrastructure.

20. The system of claim 1, wherein the system is housed within a modular, weather-resistant enclosure configured for installation on the mobile platform and operation in railway environments.
